(19) United States
(12) Patent Application Publication
(10) Pub. No.: US 2012/0094825 A1
(43) Pub. Date: Apr. 19, 2012

(54) METHOD FOR PRODUCING ELECTRODE CATALYST

(75) Inventors: Takeshi Hattori, Abiko-shi (JP); Yutaka Ito, Tsukuba-shi (JP); Hajime Maki, Tsukuba-shi (JP); Kenichiro Ota, Koganei-shi (JP)

(73) Assignee: SUMITOMO CHEMICAL COMPANY, LIMITED, Chuo-ku Tokyo (JP)

(21) Appl. No.: 13/377,041

(22) PCT Filed: Jun. 16, 2010
(86) PCT No.: PCT/JP2010/060593

§ 371 Date: Dec. 8, 2011

(30) Foreign Application Priority Data
Jun. 26, 2009 (JP) 2009-152028

(51) Int. Cl. B01J 21/18

(52) U.S. Cl. 502/182

(57) ABSTRACT

A method for producing an electrode catalyst, comprising a step of calcining a precursor of the electrode catalyst under conditions under which a second material defined below can change into a carbonaceous material, the precursor having been obtained by continuously hydrothermally reacting a mixture containing a first material defined below and the second material defined below in the presence of supercritical or subcritical water, wherein
the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and
the second material is defined to be a precursor of a carbonaceous material.

### TECHNICAL FIELD

The present invention relates to a method for producing an electrode catalyst.

### BACKGROUND ART

An electrode catalyst is a solid catalyst to be supported on an electrode (particularly on a surface region of an electrode), and has been used, for example, in electrolysis equipments for water, electrolysis equipments for organic matters, and electrochemical systems such as fuel cells. As an electrode catalyst for use in an acidic electrolyte, a noble metal can be mentioned. Among noble metals, platinum is particularly stable in an acidic electrolyte even at high potential, and thus has been widely used.

However, platinum is expensive, and its resources are limited. Accordingly, there is a demand for an electrode catalyst made of a material which is relatively inexpensive and whose resources are relatively abundant.

As an electrode catalyst that is relatively inexpensive and can be used in an acidic electrolyte, tungsten carbide is known (see Non-patent Document 1 below). Further, as an electrode catalyst that is hardly soluble when used at high potential, an electrode catalyst made of zirconium oxide is known (see Non-patent Document 2 below).
Non-patent Document 1: Hiroshi Yoneyama et al., “Electrochemistry” Vol. 41, page 719 (1973)
Nonpatent Document 2: Yan Liu et al., “Electrochemical and Solid-State Letters” 8 (8), 2005, A400-402

### DISCLOSURE OF THE INVENTION

The electrode catalyst made of tungsten carbide mentioned above has a problem in that it dissolves at high potential.

Meanwhile, with respect to the electrode catalyst made of zirconium oxide, the current value that can be drawn is small, and these electrode catalysts are not sufficiently durable for use as electrode catalysts. An object of the present invention is to provide a method for producing a highly active electrode catalyst that can be obtained using a material which is relatively inexpensive and whose resources are relatively abundant, and can also be used in an acidic electrolyte even at high potential.

The present invention provides the following means.

<1> A method for producing an electrode catalyst, comprising a step of calcining a precursor of the electrode catalyst under conditions under which a second material defined below can change into a carbonaceous material, the precursor having been obtained by continuously hydrothermally reacting a mixture containing a first material defined below and the second material defined below in the presence of supercritical or subcritical water, wherein
the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and
the second material is defined to be a precursor of a carbonaceous material.
   <2> A method for producing an electrode catalyst, comprising a step of calcining a precursor of the electrode catalyst under conditions under which a second material defined below can change into a carbonaceous material, the precursor having been obtained by mixing a reaction product with the second material defined below, the reaction product having been obtained by continuously hydrothermally reacting a first material defined below in the presence of supercritical or subcritical water, wherein
the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and
the second material is defined to be a precursor of a carbonaceous material.
   <3> The method according to <1> or <2>, wherein the metal element in the first material is Zr or Ti.
   <4> The method according to any one of <1> to <3>, wherein an atmosphere of the calcination is an oxygen-free atmosphere.

### BRIEF DESCRIPTION OF THE DRAWINGS

FIG. 1 is a schematic diagram showing the overview of a reaction apparatus (flow reaction apparatus) that is capable of continuously carrying out a hydrothermal reaction.

FIG. 2 is a schematic diagram showing the overview of a reactor placed in a flow reaction apparatus.

### EXPLANATION OF REFERENCE NUMERALS

11, 21, Water tank; 22, Raw material tank; 13, 23, Liquid-sending pump; 14, 24, Heater; 30, Mixing section; 40, Reactor; 41, Inner pipe; 44, Heater; 51, Cooler; 52, Filter; 53, Back-pressure valve; 60, Recovery container; 110, 210, 220, Valve

### MODE FOR CARRYING OUT THE INVENTION

### First Invention

The method for producing an electrode catalyst of the present invention includes a step of calcining a precursor of the electrode catalyst under conditions under which a second material defined below can change into a carbonaceous material, the precursor having been obtained by continuously hydrothermally reacting a mixture containing a first material defined below and the second material defined below in the presence of supercritical or subcritical water.

Here, the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and the second material is defined to be a precursor of a carbonaceous material.

### Second Invention

The method for producing an electrode catalyst of the present invention includes a step of calcining a precursor of the electrode catalyst under conditions under which a second material defined below can change into a carbonaceous material, the precursor having been obtained by mixing a reaction product with the second material defined below, the reaction product having been obtained by continuously hydrothermally reacting a first material defined below in the presence of supercritical or subcritical water.

Here, the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and the second material is defined to be a precursor of a carbonaceous material.

According to the present invention mentioned above, an electrode catalyst can be obtained using a material which is relatively inexpensive and whose resources are relatively abundant. Also, an electrode catalyst that shows relatively high activity in an acidic electrolyte even at a relatively high potential of 0.4 V or more, for example, can be obtained.

The first material used in the method of the present invention is a metal compound composed of one or more metal elements selected from the group consisting of the elements of Group 4A and the elements of Group 5A and one or more non-metal elements selected from the group consisting of hydrogen, nitrogen, chlorine, carbon, boron, sulfur, and oxygen. The metal element in the metal compound as the first material is preferably a metal element of the elements of Group 4A or a metal element of the elements of Group 5A, more preferably Zr, Ti, Ta, or Nb, still more preferably Zr or Ti, and particularly preferably Ti. Further, the non-metal element in the metal compound is preferably one or more non-metal elements selected from the group consisting of hydrogen, chlorine, and oxygen. Examples of metal compounds in the case where the metal element is Zr include zirconium hydroxide and zirconium oxychloride. Examples of metal compounds in the case where the metal element is Ti include titanium hydroxide, titanium tetrachloride, metatitanic acid, orthotitanic acid, titanium sulfate, and titanium alkoxide.

The second material used in the method of the present invention is a carbonaceous material precursor. The carbonaceous material precursor can change into a carbonaceous material by calcination. Examples of carbonaceous material precursors include saccharides such as glucose, fructose, sucrose, cellulose and hydroxypropyl cellulose, alcohols such as polyvinyl alcohol, glycols such as polyethylene glycol and polypropylene glycol, polyesters such as polyethylene terephthalate, nitriles such as acrylonitrile and polyacrylonitrile, various proteins such as collagen, keratin, ferritin, hormone, hemoglobin and albumin, biological materials such as amino acids, e.g., glycine, alanine, and methionine, ascorbic acid, citric acid, and stearic acid. Among the above materials, it is particularly preferable that the second material be an oxygen-containing material.

In the first invention mentioned above, a mixture containing the first material and the second material is continuously hydrothermally reacted in the presence of supercritical or subcritical water to give a precursor of an electrode catalyst. In the first invention, when an oxygen-containing material is used as the second material, the resulting precursor of an electrode catalyst can have an M-O—C bond (here, M is one or more metal elements selected from the group consisting of the elements of Group 4A and the elements of Group 5A, O is oxygen, and C is carbon). From the viewpoint of obtaining a more highly active electrode catalyst, it is preferable that the precursor of an electrode catalyst have an M-O—C bond. In this case, it is preferable that the strength of the M-O—C bond be high. Specifically, the M-O—C bond strength is preferably 0.015 or more and more preferably 0.020 or more.

In the second invention mentioned above, a reaction product obtained by continuously hydrothermally reacting the first material in the presence of supercritical or subcritical water is mixed with the second material to give a precursor of an electrode catalyst.

For the mixing, a commonly used industrial apparatus, such as a ball mill, a V-shaped mixer, or a stirrer, can be used. Mixing at this time may be dry mixing or wet mixing. Further, after wet mixing, drying may be performed at a temperature that will not cause the decomposition of the carbonaceous material precursor.

Incidentally, the supercritical point of water is 374° C., 22 MPa. In the present invention, supercritical water refers to water under the conditions of a temperature of 374° C. or more and a pressure of 22 MPa or more. Further, in the present invention, subcritical water refers to water under the conditions of a temperature of 250° C. or more, and the pressure is preferably 20 MPa or more. Further, in the present invention, as a reaction apparatus for carrying out a hydrothermal reaction, a continuous (flow) reaction apparatus can be used.

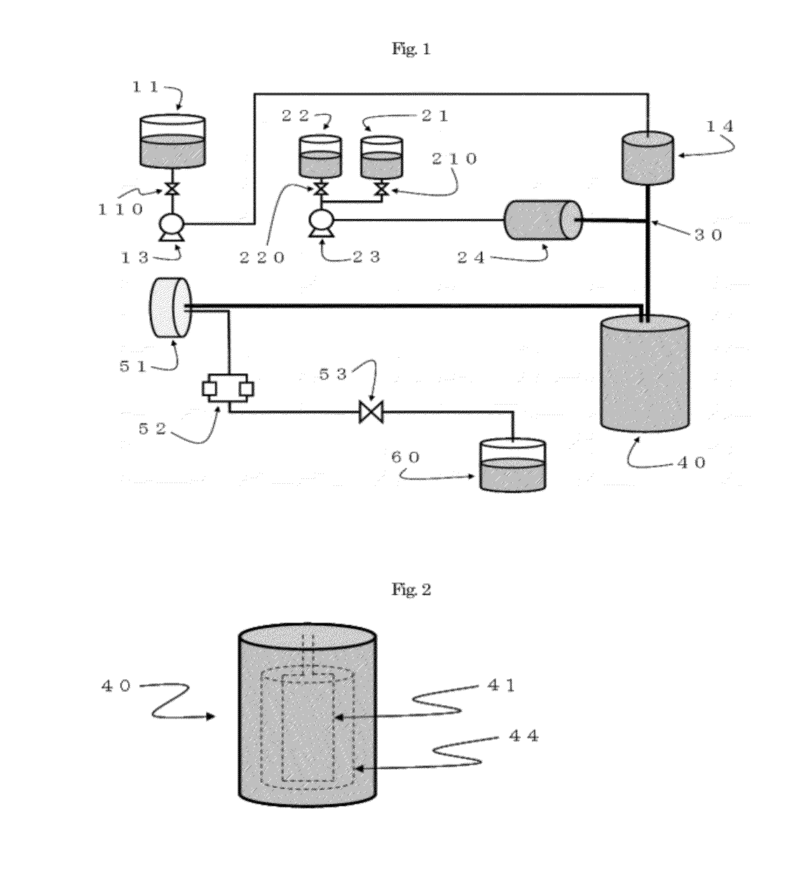

Hereinafter, a reaction apparatus for continuously carrying out a hydrothermal reaction in the present invention will be described with reference to the drawings. FIG. 1 is a schematic diagram showing the overview of a flow reaction apparatus for continuously carrying out a hydrothermal reaction. Water tanks 11 and 21 are tanks for feeding water. A raw material tank 22 is a tank for feeding a raw material slurry. Valves 110, 210, and 220 are opened to feed a liquid from these tanks. In the case of the first invention mentioned above, the raw material slurry is a slurry or aqueous solution of a mixture containing the first material and the second material. In the case of the second invention mentioned above, the raw material slurry is a slurry or aqueous solution of the first material. A liquid-sending pump 13 is driven to send a liquid from the water tank 11 to a heater 14, and a liquid-sending pump 23 is driven to send a liquid from the water tank 21 or the raw material tank 22 to a heater 24.

In the heater 24, the raw material slurry can be preheated. The preheating temperature is preferably 100° C. to 330° C. and more preferably 150° C. to 300° C. In the first invention, it is preferable that a mixture containing the first material and the second material be preheated. In this case, it is more preferable that the second material be an oxygen-containing material. The preheating of a mixture containing the first material and the second material which is an oxygen-containing material makes it possible to further increase the M-O—C bond strength of the resulting precursor of an electrode catalyst. Therefore, a more highly active electrode catalyst is obtained. The preheating of the mixture may allow the mixture to partially undergo a hydrothermal reaction.

The liquids sent to the heater 14 and the heater 24, respectively, are mixed in a mixing section 30 and undergo a hydrothermal reaction mainly in a reactor 40. FIG. 2 shows the overview of the reactor. In the reactor 40 are an inner pipe 41 and a heater 44 for heating the pipe. The inner pipe 41 is connected to an outer pipe. After a hydrothermal reaction, the produced slurry is cooled by a cooler 51, passed through a back-pressure valve 53, and recovered in a recovery container 60.

In FIG. 1, the valve 110 and the valve 210 (or the valve 220) are opened, the liquid-sending pumps 13 and 23 are operated, and also the back-pressure valve 53 is opened/closed, whereby the pressure in the pipe from the liquid-sending pumps 13 and 23 to the back-pressure valve 53 can be adjusted. Further, the temperatures of the heaters 14 and 24 and the heater 44 in the reactor 40 are adjusted, whereby supercritical or subcritical water can be obtained.

More specifically, the liquid-sending pumps 13 and 23 are driven to suitably adjust the pressure in the pipe using the back-pressure valve 53, thereby suitably adjusting the temperatures of the heaters 14 and 24 and the heater 44 in the reactor 40; thus, water in the reactor is adjusted to supercritical or subcritical. When a raw material slurry is sent from the raw material tank 22, a hydrothermal reaction takes place in the pipe after the mixing section 30 to produce a hydrothermal reaction product, and the produced slurry can be recovered in the recovery container 60. Before or after the raw material slurry is sent from the raw material tank 22, water may be sent from the water tank 21, whereby preheating of the pipe, washing of the pipe, or the like can be performed. After the hydrothermal reaction, with respect to the produced slurry, coarse particles may be removed using a filter 52 to adjust the particle size of particles in the slurry.

The reaction time can be adjusted by adjusting the length of the inner pipe 41 in the reactor 40. By selecting and using the shape of the inner pipe 41 from various shapes such as zigzag and spiral, the length of the inner pipe 41 can be adjusted.

With respect to the materials for the pipe and the inner pipe, appropriate materials should be selected based on the conditions such as the kind of raw material slurry, the hydrothermal reaction temperature, pressure, etc. Examples of materials include stainless steels such as SUS316, nickel alloys such as Hastelloy and Inconel, and titanium alloys. Depending on the characteristics of the liquid to pass therethrough, the inner surface of the pipe may be partially or completely lined with a highly corrosion-resistant material, such as gold.

With respect to the produced slurry recovered in the recovery container 60, which is a hydrothermal reaction product, the hydrothermal reaction product may be subjected to solid-liquid separation, washed, and then dried for use in a powder form as a precursor of an electrode catalyst, or may also be used in a slurry form.

In the case of the first invention mentioned above, the hydrothermal reaction product is used as the precursor of an electrode catalyst. In the case of the second invention mentioned above, a mixture of the hydrothermal reaction product and the second material is used as the precursor of an electrode catalyst.

As a result of the calcination of the precursor of an electrode catalyst under the conditions under which the second material can change into a carbonaceous material, the electrode catalyst in the present invention is obtained. The calcination atmosphere is preferably an oxygen-free atmosphere for the efficient synthesis of the electrode catalyst. In terms of cost, the oxygen-free atmosphere is preferably a nitrogen atmosphere. A furnace used for the calcination may be a furnace capable of controlling the atmosphere, and examples thereof include tubular electric furnaces, tunnel furnaces, far-infrared furnaces, microwave heating furnaces, roller hearth furnaces, and rotary furnaces. Calcination may be performed in a batch process or in a continuous process. Further, calcination may be performed in a static manner in which the precursor of an electrode catalyst is calcined while the precursor is in a static state, or it may also be performed in a fluid manner in which the precursor of an electrode catalyst is calcined while the precursor is in a fluid state.

The calcination temperature may be suitably determined in consideration of the kind of carbonaceous material precursor and the kind of calcination atmosphere. It may be a temperature at which the carbonaceous material precursor changes into a carbonaceous material, i.e., a temperature at which the carbonaceous material precursor is decomposed and carbonized. Specifically, the calcination temperature is, for example, 400° C. to 1100° C., preferably 500° C. to 1000° C., more preferably 500° C. to 900° C., and still more preferably 700° C. to 900° C. The BET specific surface area of the electrode catalyst can be controlled by controlling the calcination temperature. Incidentally, in the present invention, the conditions under which the second material can change into a carbonaceous material refer to the conditions where the second material can be decomposed and thus carbonized into a carbonaceous material.

The temperature rise rate during calcination is not particularly limited as long as it is within a practical range, and is usually 10° C./hour to 600° C./hour, and preferably 50° C./hour to 500° C./hour. The temperature may be raised to the calcination temperature at such a temperature rise rate, and maintained for around from 0.1 hours to 24 hours, preferably around from 1 hour to about 12 hours, to perform calcination.

The carbon content of the electrode catalyst in the present invention is preferably 0.1 mass % or more and 50 mass % or less, more preferably 0.5 mass % or more and 45 mass % or less, still more preferably 3 mass % or more and 40 mass % or less, and particularly preferably 15 mass % or more and 35 mass % or less. In the present invention, an Ig-loss value is used as carbon content. Specifically, the value of carbon content, which is calculated by the following formula when an electrode catalyst is placed in an alumina crucible and calcined in ambient atmosphere at 1000° C. for 3 hours, is used.

Carbon content (mass %)=(W_{I}−W_{A})/W_{I}×100

(wherein W_{I} is the electrode catalyst mass before calcination, and W_{A} is the mass after calcination.)

The electrode catalyst obtained by the method of the present invention mentioned above is an electrode catalyst which, in an acidic electrolyte, does not dissolve even at high potential and can show relatively high activity.

In the present invention, the BET specific surface area of the electrode catalyst is preferably 15 m²/g or more and 500 m²/g or less, and more preferably 50 m²/g or more and 300 m²/g or less. When the BET specific surface area is set like this, higher activity can be achieved.

In the present invention, the carbon coverage on the electrode catalyst determined by the following formula (I) is preferably 0.05 or more and 0.5 or less, and more preferably 0.1 or more and 0.3 or less.

Carbon coverage=Carbon content (mass %)/BET specific surface area (m²/g) (1)

In the present invention, in order to accelerate an electrode reaction, the work function value of the electrode catalyst is preferably 2 eV or more and 6 eV or less, and more preferably 3 eV or more and 5 eV or less. As the work function value, when measurement is performed using a photoelectron spectrometer “AC-2” manufactured by Riken Keiki under the conditions of actinography at 500 nW and a measurement energy of 4.2 to 6.2 eV, the energy value at the time of current detection can be used.

It is preferable that the electrode catalyst obtained by the method of the present invention be an electrode catalyst which is made of a metal compound containing titanium and oxygen and a carbonaceous material covering at least a part of the compound and have a BET specific surface area of 15 m²/g or more and 500 m²/g or less. The use of the electrode catalyst as an electrode catalyst in an electrochemical system makes it possible to draw a higher oxygen reduction current. Resources of titanium are abundant, and this is advantageous in spreading electrochemical systems such as fuel cells, increasing their size, etc.

The use of the electrode catalyst obtained by the method of the present invention also makes it possible to obtain an electrode catalyst composition containing an electrode catalyst. The electrode catalyst composition usually contains a dispersion medium. The electrode catalyst composition can be obtained by dispersing the electrode catalyst in the dispersion medium. Examples of dispersion media are alcohols such as methanol, ethanol, isopropanol, and n-propanol, and water such as ion-exchange water.

In dispersion, a dispersant may be used. Examples of dispersants include inorganic acids such as nitric acid, hydrochloric acid, and sulfuric acid, organic acids such as oxalic acid, citric acid, acetic acid, malic acid, and lactic acid, water-soluble zirconium salts such as zirconium oxychloride, surfactants such as ammonium polycarboxylate and sodium polycarboxylate, and catechins such as epicatechin, epigallocatechin, and epigallocatechin gallate.

The electrode catalyst composition may also contain an ion-exchange resin. When an ion-exchange resin is contained, such an electrode catalyst composition is particularly suitable for fuel cells. Examples of ion-exchange resins include fluorine-based ion-exchange resins such as Nafion (registered trademark of Du Pont), and cation-exchange resins such as hydrocarbon-based ion-exchange resins such as sulfonated phenol formaldehyde resins.

The electrode catalyst composition may also contain an electrically conductive material. Examples of electrically conductive materials include carbon fibers, carbon nanotubes, carbon nanofibers, electrically conductive oxides, electrically conductive oxide fibers, and electrically conductive resins. Further, the electrode catalyst composition may also contain noble metals, such as Pt and Ru, and transition metals, such as Ni, Fe, and Co. In the case where these noble metals and transition metals are contained, it is preferable that their contents be extremely low (e.g., around from 0.1 to 10 parts by mass relative to 100 parts by mass of the electrode catalyst).

In the present invention, the electrode catalyst can be used in an electrochemical system, and can be used preferably as an electrode catalyst for fuel cells, more preferably as an electrode catalyst for polymer electrolyte fuel cells, and still more preferably as an electrode catalyst in the cathode part of a polymer electrolyte fuel cell.

The electrode catalyst in the present invention is suitable for use in an acidic electrolyte at a potential of 0.4 V or more relative to the reversible hydrogen electrode potential, and has relatively high activity. Therefore, in an electrochemical system, for example, the electrode catalyst is useful as an oxygen reduction catalyst to be supported on an electrode and used for reducing oxygen. In the case where it is used as an oxygen reduction catalyst, the preferred upper limit of potential depends on the stability of the electrode catalyst, and it can be used up to a potential of about 1.6 V, at which oxygen is generated. When the potential exceeds 1.6 V, at the same time as the generation of oxygen, the electrode catalyst is gradually oxidized from the surface, whereby the electrode catalyst may be completely oxidized and inactivated. A potential of less than 0.4 V could be suitable in terms of the stability of the electrode catalyst. However, in terms of being an oxygen reduction catalyst, the usefulness may be poor.

The electrode catalyst composition can also be supported on an electrode such as a carbon cloth or a carbon paper, and used in the electrolysis of water, the electrolysis of an organic matter, or the like in an acidic electrolyte. Further, it can also be supported on an electrode that forms a fuel cell, such as a polymer electrolyte fuel cell or a phosphoric acid fuel cell, and used.

### EXAMPLES

Hereinafter, the present invention will be described in more detail with reference to examples. However, the present invention is not limited to these examples.

Incidentally, the evaluation methods in each example are as follows.

(1) BET specific surface area (m²/g) was determined by the nitrogen adsorption method.
(2) Crystal structure was analyzed using a powder X-ray diffractometer.
(3) As carbon content, the value of carbon content (Ig-loss value), which is calculated by the following formula when an electrode catalyst obtained is placed in an alumina crucible and calcined in a box furnace in ambient atmosphere at 1000° C. for 3 hours, was used.

Carbon content (mass %)=(W_{I}−W_{A})/W_{I}×100

(wherein W_{I} is the electrode catalyst mass before calcination, and W_{A} is the mass after calcination.)
(4) Carbon coverage was calculated by the following formula.

Carbon coverage=Carbon content (mass %)/BET specific surface area (m²/g)

(5) The M-O—C bond strength of a specimen was determined by Fourier transform infrared spectroscopy. As the apparatus, a Fourier transform infrared spectrometer (manufactured by JASCO Engineering, apparatus name: WIR-460PLUS) was used, and an ATR attachment was used. The resolution is 4 cm⁻¹, and the number of acquisitions is 32. M-O—C bond strength is the value of the intensity of absorbance at 1600 cm⁻¹ (here, the background value is eliminated).

### Production Example 1

### Preparation of First Material (Ti-Containing Compound

Using an aqueous titanium sulfate (IV) solution (manufactured by Kanto Chemical, diluted to 12 mass % titanium sulfate) and an aqueous NH₃ (manufactured by Kanto Chemical, diluted to 4 mass %), they were neutralized, and the resulting precipitate was filtered and washed to give a first material (Ti-containing compound). In an aqueous NH₃ with pH adjusted to 10.5, the first material was dispersed at a concentration of 1 mass % to give a Ti-containing compound slurry.

### Production Example 2

### Preparation of First Material (Zr-Containing Compound

Using an aqueous solution obtained by dissolving zirconium oxychloride (manufactured by Wako Pure Chemical Industries) in pure water (8 mass % zirconium oxychloride) and an aqueous NH₃ (manufactured by Kanto Chemical, diluted to 4 mass %), they were neutralized, and the resulting precipitate was filtered and washed to give a first material (Zr-containing compound). As a result of powder X-ray diffraction measurement, the first material was identified as zirconium hydroxide. In an aqueous NH₃ with pH adjusted to 10.5, the first material was dispersed at such a concentration that the first material was 1 mass %, thereby giving a Zr-containing compound slurry.

### Production Example 3

### Preparation of First Material (Zr-Containing Compound

Zirconium hydroxide (manufactured by Daiichi Kigenso Kagaku Kogyo, R-type zirconium hydroxide) was used as a first material. In an aqueous NH₃ with pH adjusted to 10.5, the first material was dispersed at such a concentration that the first material was 1 mass %, thereby giving a Zr-containing compound slurry.

### Example 1

### Preparation of Electrode Catalyst

As a first material slurry, the Ti-containing compound slurry obtained in Production Example 1 was used. As a second material, glucose (manufactured by Wako Pure Chemical Industries) was used. A mixture obtained by adding 12 g of glucose to 1200 mL of the Ti-containing compound slurry was placed in a raw material tank 22 of a flow reaction apparatus that can be represented by FIG. 1. Water was placed in water tanks 11 and 21, liquid-sending pumps 13 and 23 were driven, and valves 110 and 210 were opened, thereby starting the liquid sending of water. Here, the liquid flow rate in the liquid-sending pump 13 was adjusted to 16.7 mL/min, while the liquid flow rate in the liquid-sending pump 23 was adjusted to 3.33 mL/min. Using a back-pressure valve 53, the pressure in the pipe was adjusted to 30 MPa. The temperatures of a heater 14, a heater 24, and a heater 44 in a reactor 40 were adjusted to 400° C., 250° C., and 350° C., respectively. The liquid temperature in a mixing section 30 in the steady state was measured. As a result, the temperature was 380° C., confirming that water in the mixing section 30 was in the supercritical state. Subsequently, the valve 210 was closed and a valve 220 was opened, thereby switching the liquid-feeding tank from the water tank 21 to a raw material tank 22. The raw material slurry was fed from the raw material tank 22 to carry out a hydrothermal reaction, and the produced slurry was recovered in a recovery container 60. The recovered produced slurry was subjected to solid-liquid separation by filtration, and dried at 60° C. for 3 hours to give a precursor of an electrode catalyst. The precursor was placed in a boat made of alumina. Then, in a tubular electric furnace with an inner volume of 13.4 L [manufactured by Motoyama], the temperature was raised from room temperature (around 25° C.) to 800° C. at a temperature rise rate of 300° C./hour while circulating a nitrogen gas at a flow rate of 1.5 L/min, and maintained at 800° C. for 1 hour to calcine the precursor, thereby giving an electrode catalyst 1. The obtained electrode catalyst 1 was a carbon-coated titanium oxide. The electrode catalyst 1 had a BET specific surface area of 75 m²/g, a carbon content of 15 mass %, and a carbon coverage of 0.2, and its crystal form was tetragonal (anatase).

### [Evaluation in Electrochemical System]

0.02 g of the electrode catalyst 1 was weighed and added to a mixed solvent of 5 mL of pure water and 5 mL of isopropyl alcohol. The mixture was ultrasonically irradiated to give a suspension. 20 μL of the suspension was applied to a glassy carbon electrode [6 mm in diameter, electrode area: 28.3 mm²], and dried. Then, 13 μL of “Nafion (registered trademark)” [manufactured by Du Pont, 10-fold diluted sample with a solid concentration of 5 mass %] was applied thereonto, dried, and further treated in a vacuum dryer for 1 hour, thereby giving a modified electrode having the electrode catalyst 1 supported on the glassy carbon electrode. The modified electrode was immersed in a 0.1 mol/L aqueous sulfuric acid solution. At room temperature and atmospheric pressure, in an oxygen atmosphere and a nitrogen atmosphere, the potential was cycled at a scanning rate of 50 mV/s within a scanning range of −0.25 to 0.75 V (0.025 to 1.025 V in terms of reversible hydrogen electrode potential) relative to the silver-silver chloride electrode potential. The current value at each potential was compared between cycles to check electrode stability. As a result, there was no variation in current value within the scanning potential range, and the current value at each potential was stable in every cycle. Further, the current values in an oxygen atmosphere and a nitrogen atmosphere were compared at a potential of 0.4 V relative to the reversible hydrogen electrode potential to determine the oxygen reduction current. As a result, the oxygen reduction current was 2409 μA/cm² per unit area of the electrode.

### Example 2

### Preparation of Electrode Catalyst

As a first material slurry, the Zr-containing compound slurry obtained in Production Example 2 was used. As a second material, glucose (manufactured by Wako Pure Chemical Industries) was used. A mixture obtained by adding 6 g of glucose to 600 mL of the Zr-containing compound slurry was placed in a raw material tank 22 of a flow reaction apparatus that can be represented by FIG. 1. Water was placed in water tanks 11 and 21, liquid-sending pumps 13 and 23 were driven, and valves 110 and 210 were opened, thereby starting the liquid sending of water. Here, the liquid flow rate in the liquid-sending pump 13 was adjusted to 16.7 mL/min, while the liquid flow rate in the liquid-sending pump 23 was adjusted to 6.66 mL/min. Using a back-pressure valve 53, the pressure in the pipe was adjusted to 30 MPa. The temperatures of a heater 14, a heater 24, and a heater 44 in a reactor 40 were adjusted to 400° C., 250° C., and 350° C., respectively. The liquid temperature in a mixing section 30 in the steady state was measured. As a result, the temperature was 380° C., confirming that water in the mixing section 30 was in the supercritical state. Subsequently, the valve 210 was closed and a valve 220 was opened, thereby switching the liquid-feeding tank from the water tank 21 to a raw material tank 22. The raw material slurry was fed from the raw material tank 22 to carry out a hydrothermal reaction, and the produced slurry was recovered in a recovery container 60. The recovered produced slurry was subjected to solid-liquid separation by filtration, and dried at 60° C. for 3 hours to give a precursor of an electrode catalyst. The precursor was placed in a boat made of alumina. Then, in a tubular electric furnace with an inner volume of 13.4 L [manufactured by Motoyama], the temperature was raised from room temperature (around 25° C.) to 800° C. at a temperature rise rate of 300° C./hour while circulating a nitrogen gas at a flow rate of 1.5 L/min, and maintained at 800° C. for 1 hour to calcine the precursor, thereby giving an electrode catalyst 2. The obtained electrode catalyst 2 was a carbon-coated zirconium oxide. The electrode catalyst 2 had a BET specific surface area of 116 m²/g, a carbon content of 8.5 mass %, and a carbon coverage of 0.07, and its crystal form was a mixture of tetragonal and orthorhombic phases.

### [Evaluation in Electrochemical System]

Evaluation in an electrochemical system was performed in the same manner as in Example 1, except that the electrode catalyst 2 was used in place of the electrode catalyst 1. As a result, there was no variation in current value within the scanning potential range, and the current value at each potential was stable in every cycle. Further, the current values in an oxygen atmosphere and a nitrogen atmosphere were compared at a potential of 0.4 V relative to the reversible hydrogen electrode potential to determine the oxygen reduction current. As a result, the oxygen reduction current was 1219 μA/cm² per unit area of the electrode.

### Example 3

### Preparation of Electrode Catalyst

As a first material slurry, the Zr-containing compound slurry obtained in Production Example 3 was used. As a second material, glucose (manufactured by Wako Pure Chemical Industries) was used. A mixture obtained by adding 2.6 g of glucose to 175 g of the Zr-containing compound slurry was placed in a raw material tank 22 of a flow reaction apparatus that can be represented by FIG. 1. Water was placed in a water tank 11, liquid-sending pumps 13 and 23 were driven, and valves 110 and 210 were opened, thereby starting the liquid sending of the raw material slurry and water. Here, the liquid flow rate in the liquid-sending pump 13 was adjusted to 8 mL/min, while the liquid flow rate in the liquid-sending pump 23 was adjusted to 3.4 mL/min. The pressure in the pipe was adjusted to 20 MPa. This pressure is a subcritical condition. The temperatures of a heater 14, a heater 24, and a heater 44 in a reactor 40 were adjusted to 400° C., 250° C., and 350° C., respectively, and a hydrothermal reaction was carried out. The produced slurry was recovered in a recovery container 60. The recovered produced slurry was subjected to solid-liquid separation by centrifugation, and the obtained precipitate was dried at 60° C. to give a precursor of an electrode catalyst. For the centrifugation, a centrifugal separator (manufactured by Kubota Seisakusho, Model 9912) was used, and the produced slurry was centrifuged at 3000 rpm for 10 minutes. The M-O—C bond strength of the obtained precursor of an electrode catalyst was 0.176. The precursor was placed in a boat made of alumina. Then, in a tubular electric furnace with an inner volume of 13.4 L [manufactured by Motoyama], the temperature was raised from room temperature (around 25° C.) to 800° C. at a temperature rise rate of 300° C./hour while circulating a nitrogen gas at a flow rate of 1.5 L/min, and maintained at 800° C. for 1 hour to calcine the precursor, thereby giving an electrode catalyst 3. The obtained electrode catalyst 3 was a carbon-coated zirconium oxide. The electrode catalyst 3 had a BET specific surface area of 119 m²/g, a carbon content of 20.9 mass %, and a carbon coverage of 0.18, and its crystal form was a mixture of tetragonal and orthorhombic phases.

### [Evaluation in Electrochemical System]

Evaluation in an electrochemical system was performed in the same manner as in Example 1, except that the electrode catalyst 3 was used in place of the electrode catalyst 1. As a result, there was no variation in current value within the scanning potential range, and the current value at each potential was stable in every cycle. Further, the current values in an oxygen atmosphere and a nitrogen atmosphere were compared at a potential of 0.4 V relative to the reversible hydrogen electrode potential to determine the oxygen reduction current. As a result, the oxygen reduction current was 2920 μA/cm² per unit area of the electrode.

### Example 4

### Preparation of Electrode Catalyst

A precursor of an electrode catalyst was obtained in the same manner as in Example 3, except that the heater 24 was not turned on. This case is also a subcritical condition. The M-O—C bond strength of the obtained precursor of an electrode catalyst was 0.075. The precursor was calcined in the same manner as in Example 3 to give an electrode catalyst 4. The obtained electrode catalyst 4 was a carbon-coated zirconium oxide. The electrode catalyst 4 had a BET specific surface area of 113 m²/g, a carbon content of 8.5 mass %, and a carbon coverage of 0.08, and its crystal form was a mixture of tetragonal and orthorhombic phases.

### [Evaluation in Electrochemical System]

Evaluation in an electrochemical system was performed in the same manner as in Example 1, except that the electrode catalyst 4 was used in place of the electrode catalyst 1. As a result, there was no variation in current value within the scanning potential range, and the current value at each potential was stable in every cycle. Further, the current values in an oxygen atmosphere and a nitrogen atmosphere were compared at a potential of 0.4 V relative to the reversible hydrogen electrode potential to determine the oxygen reduction current. As a result, the oxygen reduction current was 261 μA/cm² per unit area of the electrode.

### Comparative Example 1

Evaluation in an electrochemical system was performed in the same manner as in Example 1, except that a commercially available zirconium oxide powder (manufactured by Daiichi Kigenso Kagaku Kogyo, RC-100, carbon content: 0%, BET specific surface area: 106 m²/g, carbon coverage: 0) was used in place of the electrode catalyst of Example 1. The current values in an oxygen atmosphere and a nitrogen atmosphere were compared at a potential of 0.4 V relative to the reversible hydrogen electrode potential to determine the oxygen reduction current. As a result, the oxygen reduction current was 1.5 μA/cm² per unit area of the electrode.

### INDUSTRIAL APPLICABILITY

According to the present invention, an electrode catalyst that can be used in an acidic electrolyte even at high potential and also shows high activity can be obtained. Further, an electrode catalyst can be obtained using a material which is relatively inexpensive and whose resources are relatively abundant, and, therefore, the present invention is industrially extremely useful.

1. A method for producing an electrode catalyst, comprising a step of calcining a precursor of the electrode catalyst under conditions under which a second material defined below can change into a carbonaceous material, the precursor having been obtained by continuously hydrothermally reacting a mixture containing a first material defined below and the second material defined below in the presence of supercritical or subcritical water, wherein
the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and
the second material is defined to be a precursor of a carbonaceous material.

2. A method for producing an electrode catalyst, comprising a step of calcining a precursor of the electrode catalyst under conditions under which a second material defined below can change into a carbonaceous material, the precursor having been obtained by mixing a reaction product with the second material defined below, the reaction product having been obtained by continuously hydrothermally reacting a first material defined below in the presence of supercritical or subcritical water, wherein
the first material is defined to be a metal compound composed of one or more metal elements selected from the group consisting of the elements of Group 4A and the elements of Group 5A group and one or more non-metal elements selected from the group consisting of hydrogen, nitrogen, chlorine, carbon, boron, sulfur, and oxygen, and
the second material is defined to be a precursor of a carbonaceous material.

3. The method according to claim 1, wherein the metal element in the first material is Zr or Ti.

4. The method according to claim 1, wherein an atmosphere of the calcination is an oxygen-free atmosphere.
